(19) United States
(12) Patent Application Publication
(10) Pub. No.: US 2005/0109725 A1
(43) Pub. Date: May 26, 2005

(54) Baby bottle cap holder

(76) Inventors: Sylvania Antionette Stewart, Lithonia, GA (US); Lisa Lynette Cook, Matteson, IL (US)

Correspondence Address: Sylvania A. Stewart, 6441 Berryside Dr., Lithonia, GA, 30058, US

(21) Appl. No.: 10/720,854

(22) Filed: Nov. 24, 2003

(51) Int. Cl. A61J 9/08

(52) U.S. Cl. 215/11.6

(57) ABSTRACT

The provides a mechanism to help ensure that a snap on baby bottle cap is kept together with the baby bottle while the baby bottle is in use so that the snap on baby bottle cap does not get misplaced or lost entirely. The baby bottle cap can be kept loosely attached to the baby bottle by one flexible ring designed to fit directly around the baby bottle cap and another flexible ring that fits around the baby bottle. The two holding rings are attached to each other via a connector that is made of suitable material of sufficient length to connect the two rings together while allowing the baby bottle cap to be placed atop the bottle when the baby bottle cap holder is around the baby bottle.

### BACKGROUND OF THE INVENTION

Baby bottles of various shapes, sizes and contours have been in use for years. Snap on baby bottle caps are a fairly recent development in the manufacturing of baby bottles. Baby bottle users now have the convenience of a protected baby bottle nipple, ability to transport the baby bottle with minimal to no leakage but quick and easy access to the liquid contents of the baby bottle. What they do not have is a mechanism to help them keep the snap on baby bottle cap from getting misplaced from the baby bottle or lost. Many baby bottle users who are caretakers of infants and toddlers will find immediate use for this invention.

The objective of this invention is to provide a simple easy to use baby bottle cap holder that will enable a snap on baby bottle cap to be kept with the baby bottle while the bottle is in use for feeding but does not interfere with the ease of feeding.

A baby bottle cap holder that can be used with any type baby bottle or any type snap on baby bottle cap manufactured from plastic or glass.

A baby bottle cap holder which can be easily attached and detached from the snap on baby bottle cap and baby bottle.

A baby bottle cap holder that is washable and reusable.

A baby bottle cap holder capable of accommodating graphic art of the surface of the ring like bands of any suitably stretchable material to be visually appealing and a sensory stimulus to infants and toddlers.

### SUMMARY

The objective of this invention is to provide a simple device as described above which when used allows a snap on baby bottle cap to be retained close to the baby bottle in an attachment fashion.

### BRIEF DESCRIPTION OF THE DRAWING

In the accompanying drawings:

FIG. 1 is a perspective view of the upper and lower band like rings

FIG. 2 is a perspective view of the cord like connector member

FIG. 3 is a perspective view of the band like rings joined by the cord like connector member

FIG. 4 is a perspective view of the baby bottle cap holder as it would typically appear before usage with a baby bottle with its snap on bottle cap in place

FIG. 5 is a perspective view of the baby bottle cap holder as it would typically appear during usage with a baby bottle with its snap on bottle cap taken off

FIG. 6 is a perspective view of the baby bottle cap holder on a baby bottle with graphic art on the band like rings

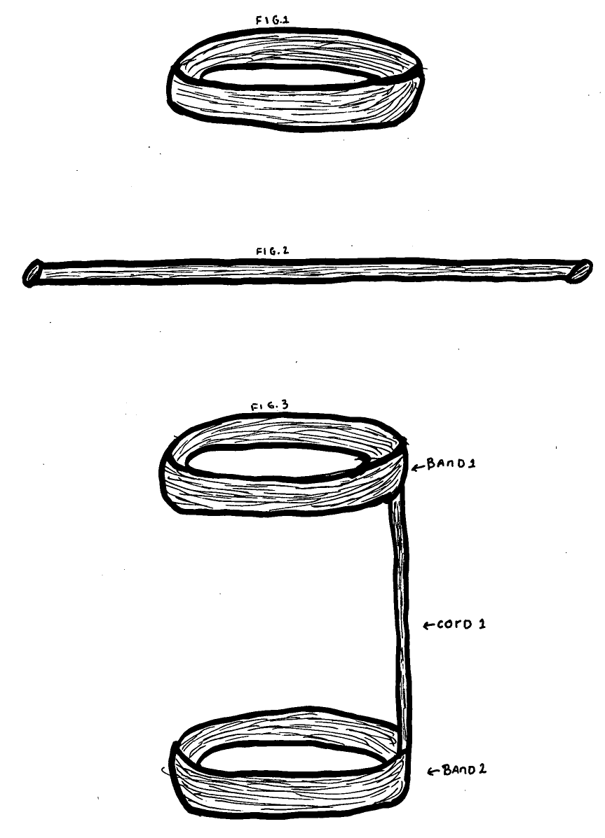

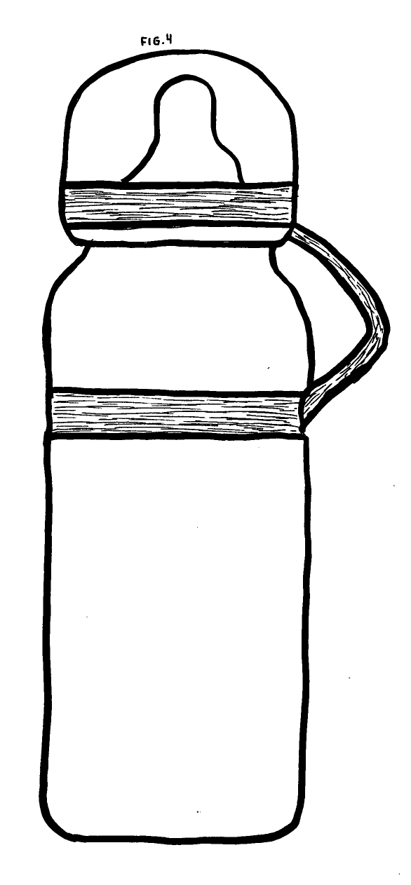

### DETAILED DESCRIPTION OF THE DRAWING

1. FIG. 3 of the accompanying drawings represents a typical embodiment of the invention comprised of the following components:

2. Two band like rings 1 and 2 made of elastic (of sufficient thickness and width) or any other suitable material of sufficient elasticity to allow the band to easily slip around a baby bottle or snap on baby bottle cap and

3. A connector of thin cord like material or any other suitable material which will facilitate connection of the two band like rings to one another with a separating cord length that is sufficient to allow the baby bottle cap to be kept essentially with the bottle but not pose any hazard

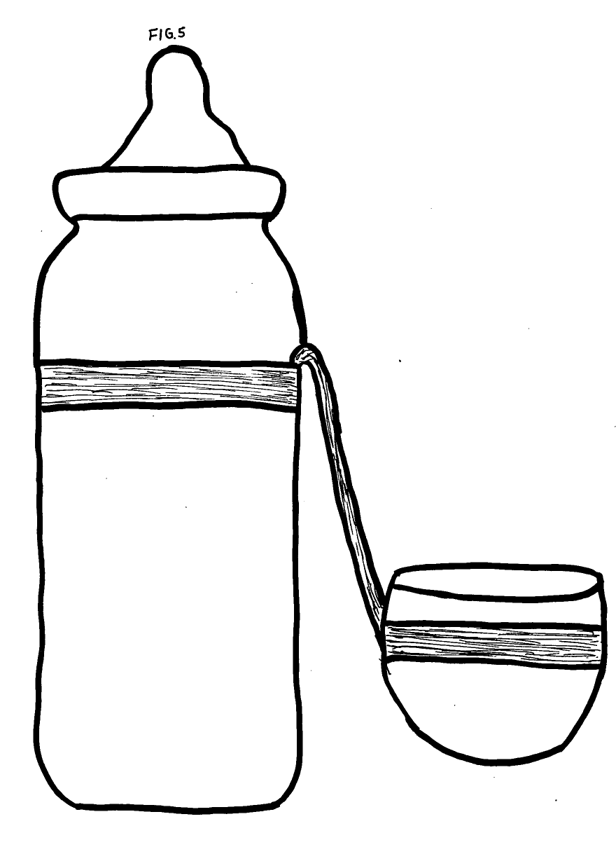

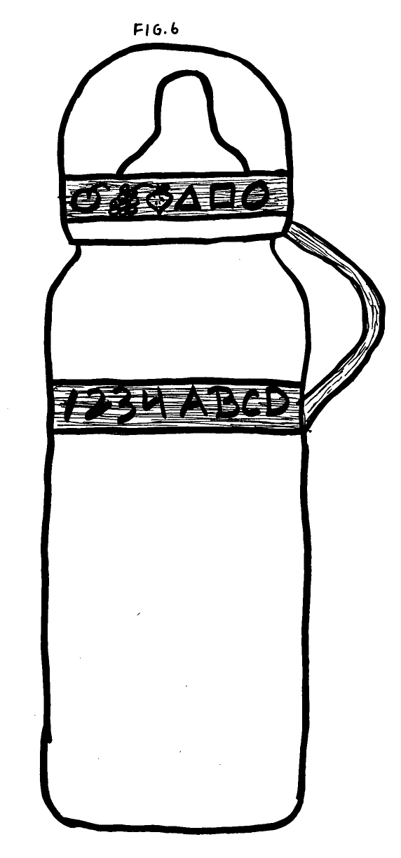

4. FIG. 4 is a depiction of the invention with graphic art on the band like rings such as numbers, alphabets, shapes, etc.

We claim that the invention is a simple to use baby bottle cap holder which when used allows a snap on baby bottle cap to be retained close by the baby bottle in an attachment fashion. The invention can be fashioned of any suitably elastic material which will allow the invention to easily fit around any suitable manufactured baby bottle with a snap on baby bottle cap. The invention will be of immediate value to any care taker of infants and toddlers who must keep track of baby bottles and their accompanying snap on caps especially in child care environments or when away from home.

1. A baby bottle cap holder to keep snap on baby bottle caps with baby bottles comprising: two elastic or other suitable material band like rings connected together via any suitable material to secure them to one another whereby one of the ring shaped elastic members is placed around the baby bottle cap and the other ring shaped elastic member is placed around the baby bottle.

2. The elastic band like rings that are placed around any suitable manufactured snap on baby bottle cap and any suitable manufactured baby bottle are made of any suitably stretchable material of sufficient elasticity to allow sufficient give to enable placement around a snap on baby bottle cap and baby bottle but not slip off unless being removed intentionally. Said band like rings may be of any width which enable them to fit securely around the snap on baby bottle cap or the baby bottle. Both band like rings may be of equal widths or unequal widths. In the case of unequal widths, the width of the band like ring which goes around the snap on baby bottle cap would be less than the width of the band like ring which goes around the baby bottle.

3. The connective member which secures ring 1 to ring 2 is made of any suitably stretchable or non-stretchable material of sufficient length to enable ring 1 to stay in place on the baby bottle cap while the baby bottle cap is either atop the baby bottle or while the baby bottle cap dangles beside the baby bottle. Said connector may be either flat or cord like.
